(19) United States
(12) Patent Application Publication
(10) Pub. No.: US 2026/0184564 A1
(43) Pub. Date: Jul. 2, 2026

(54) STEAM REFORMING CATALYST AND PROCESS

(71) Applicant: Johnson Matthey Davy Technologies Limited, London (GB)

(72) Inventors: Mileta BABOVIC, Billingham Cleveland (GB); John Robert BRIGHTLING, Billingham Cleveland (GB); Mikael CARLSSON, Billingham Cleveland (GB); Graham HINTON, Billingham Cleveland (GB); Caleb MCCULLOCH, Stockton-on-Tees (GB); John David PACH, Billingham Cleveland (GB)

(21) Appl. No.: 19/127,590

(22) PCT Filed: Dec. 19, 2023
(86) PCT No.: PCT/GB2023/053299

§ 371 Date: May 6, 2025

(30) Foreign Application Priority Data
Jan. 26, 2023 (GB) 2301101.8

(51) Int. Cl. C01B 3/40; B01J 21/04; B01J 23/89; B01J 35/30

(52) U.S. Cl. CPC C01B 3/40; B01J 21/04; B01J 23/892; B01J 35/397; C01B 2203/0233; C01B 2203/0272; C01B 2203/1011; C01B 2203/1058; C01B 2203/107; C01B 2203/1082; C01B 2203/1235

(57) ABSTRACT

A process for steam reforming in an autothermal or secondary reformer is described, comprising: (i) non-catalytically partially combusting a feed gas comprising a hydrocarbon with an oxygen-containing gas to form a partially combusted gas mixture and (ii) passing the partially combusted gas mixture through a catalyst bed comprising a first layer of a first particulate steam reforming catalyst and a second layer of a second particulate steam reforming catalyst, wherein the partially combusted gas mixture passes through the first layer and then the second layer, the second particulate steam reforming catalyst is an eggshell catalyst comprising nickel coated on a refractory support, and the first layer has a thickness in the range of 20 to 60% of the combined thickness of the first and second layers.

This invention relates to a process for steam reforming, in particular to a process for secondary or autothermal reforming.

Steam reforming is widely practised and is used to produce hydrogen streams and synthesis gas comprising hydrogen and carbon oxides for a number of processes such as ammonia and methanol synthesis and the Fischer-Tropsch process. In a secondary or autothermal reformer a hydrocarbon-containing feed is partially combusted using a suitable oxidant, e.g. air, oxygen or oxygen-enriched air in a burner mounted usually near the top of the reformer. The partial oxidation reactions are exothermic, and the combustion increases the temperature of the gas typically to between 1200 and 1500° C. The partially combusted gas is then passed adiabatically through a bed of a steam reforming catalyst disposed below the burner, to bring the gas composition towards equilibrium. Heat for the endothermic steam reforming reaction is supplied by the hot, partially combusted gas. As the partially combusted gas contacts the steam reforming catalyst it is cooled by the endothermic steam reforming reaction to temperatures in the range 900-1100° C.

EP-B-0625481 describes a steam reforming process in an autothermal reformer where, in order to prevent volatilised alumina refractory lining from the combustion zone in a reformer from depositing on the top surface of the steam reforming catalyst, the steam reforming catalyst comprises an upper layer and a lower layer, said upper layer having catalyst particles of reduced activity for the steam reforming reaction. Because of the reduced activity of the upper layer, it will be hotter than the lower layer, therefore preventing deposition of the volatilised refractory in the upper layer of the catalyst bed.

In contrast, WO2006126018 A1 discloses a process for steam reforming of hydrocarbons comprising partially oxidising a feed gas comprising a hydrocarbon feedstock with an oxygen-containing gas in the presence of steam to form a partially oxidised hydrocarbon gas mixture at a temperature >1200° C. and passing the resultant partially oxidised hydrocarbon gas mixture through a bed of steam reforming catalyst, wherein the bed comprises a first layer and a second layer, each layer comprising a catalytically active metal on an oxidic support wherein the oxidic support for the first layer is a zirconia. Preferred arrangements include a higher activity catalyst over a lower activity catalyst.

WO2012131318 A1 discloses process for the steam reforming of hydrocarbons in an autothermal or secondary reformer comprising (i) non-catalytically partially combusting a feedgas comprising a hydrocarbon with an oxygen-containing gas in the presence of steam to form a partially oxidised hydrocarbon gas mixture at a temperature ≥1200° C. and (ii) passing the partially oxidised hydrocarbon gas mixture through a first particulate layer of steam reforming catalyst, a second particulate layer of steam reforming catalyst and a third particulate layer of steam reforming catalyst, wherein the first layer comprises a catalytically active metal selected from platinum, palladium, iridium, ruthenium or rhodium supported on a zirconia, and the second and third layers comprise nickel on a refractory support selected from alumina, calcium aluminate, magnesium aluminate, titania, zirconia, magnesia or mixtures thereof, wherein the second layer has a voidage ≥0.5 and a higher equivalent passage diameter than the third layer.

We have found that eggshell nickel catalysts, in which the nickel is present only within a thin surface layer on the catalyst, are surprisingly effective catalysts for secondary or autothermal reforming but that in order to prevent nickel and support volatilisation and deactivation of the catalyst, it should be used in combination with a protective catalyst layer.

Accordingly, the invention provides a process for steam reforming in an autothermal or secondary reformer comprising: (i) non-catalytically partially combusting a feed gas comprising a hydrocarbon with an oxygen-containing gas to form a partially combusted gas mixture and (ii) passing the partially combusted gas mixture through a catalyst bed comprising a first layer of a first particulate steam reforming catalyst and a second layer of a second particulate steam reforming catalyst, wherein the partially combusted gas mixture passes through the first layer and then the second layer, the second particulate steam reforming catalyst is an eggshell catalyst comprising nickel coated on a refractory support, and the first layer has a thickness in the range of 20 to 60% of the combined thickness of the first and second layers.

The invention further provides a bed of steam reforming catalyst suitable for use on a secondary or autothermal reformer, wherein the bed comprises a first layer of a first particulate steam reforming catalyst and a second layer of a second particulate steam reforming catalyst in contact with the layer of first particulate steam reforming catalyst, wherein the second particulate steam reforming catalyst is an eggshell catalyst comprising nickel coated on a refractory support, and the first layer has a thickness in the range of 20 to 60% of the combined thickness of the first and second layers.

By the term “eggshell catalyst” we mean that the catalytically active metal is not uniformly distributed within the catalyst support but is concentrated at the surface and therefore forms a thin layer, with the catalytically active metal being absent beneath this layer.

The secondary or autothermal reformer may be of any design in which a catalyst bed comprising the first and second layers is disposed. Suitable designs are known and comprise an elongate vessel, oriented vertically, with a burner mounted at the upper end to which reactants are fed, a combustion zone beneath the burner where partial combustion of the reactants takes place, and a bed of steam reforming catalyst disposed beneath the combustion zone through which the partially combusted gas mixture passes. An outlet for the reformed gas is disposed downstream or beneath the catalyst bed. In such arrangements, the first layer is disposed directly on top of the second layer, such that the first layer may be termed the upper layer and the second layer the lower layer.

The feed gas may comprise a desulphurized hydrocarbon feedstock such as methane, natural gas or naphtha with a boiling point up to 200° C. which may be pre-heated to about 400-650° C. or may be a pre-reformed or primary-reformed gas stream comprising unreacted hydrocarbon, steam, hydrogen and carbon oxides. The latter are preferable as it may be desirable to ensure that the feed to the secondary reformer or autothermal reformer contains a low level of methane and also contains a significant amount of hydrogen, as these factors reduce the risk of carbon/soot formation above/on the steam reforming catalyst in the secondary or autothermal reformer.

The oxygen containing gas may be substantially pure oxygen, air or an oxygen enriched air. The amount of oxygen used preferably provides an oxygen to carbon molar ratio in the range of 0.4 to 1.0:1. Steam is preferably present at a steam to carbon molar ratio in the range of 0.5 to 10, preferably 0.5 to 8. Where the oxygen-containing gas is oxygen, the steam to carbon molar ratio is preferably in the range 0.5 to 4 and where the oxygen-containing gas is air, the steam to carbon molar ratio is preferably in the range 3 to 8. By “oxygen to carbon molar ratio” we mean the molar ratio of oxygen to hydrocarbon carbon in the feed gas mixture fed to the reformer. By “steam to carbon molar ratio” we mean the molar ratio of steam to hydrocarbon carbon in the feed gas mixture fed to the reformer.

Steam may be provided by adding it directly to the combustion zone or by mixing, either with the feed gas or the oxygen-containing gas. Alternatively, if the feed gas is a pre- or primary-reformed gas, no additional steam may be necessary. Furthermore, if the feed gas contains hydrogen, its combustion with oxygen will generate steam under the reaction conditions. In the preferred secondary reforming, where the secondary reformer is downstream of a fired primary reformer, the oxygen-containing gas is preferably air or oxygen-enriched air.

Hydrocarbon and any hydrogen in the feed gas are partially combusted by the oxygen in the oxygen-containing gas in a combustion zone of the secondary or autothermal reformer. The partially combusted gas mixture then passes from the combustion zone to the surface of the layer of first steam reforming catalyst. The partially combusted gas mixture may be at a temperature in the range 1100-1500° C. When the partially combusted gas mixture contacts the first steam reforming catalyst, the steam reforming reaction, which is endothermic, cools the gas and the surface of the catalyst. The surface temperature of the catalyst may therefore, depending upon the conditions and activity of the catalyst, be in the range about 900-1400° C. Preferably, the layer of the first catalyst reduces the catalyst temperature below about 1200° C., more preferably below about 1100° C. The layer of first particulate steam reforming catalyst therefore acts to protect the downstream layer of the eggshell catalyst from high temperatures that could otherwise volatilise the nickel in the eggshell coating and so render the eggshell catalyst less active.

The first particulate steam reforming catalyst may comprise a catalytically active metal consisting of one or more of nickel, platinum, palladium, iridium, ruthenium or rhodium dispersed throughout a refractory support. Nickel is preferred. In some arrangements, the particulate catalyst in the first layer may comprise 5-25% by weight nickel, expressed as NiO, dispersed through a refractory oxide catalyst support. The dispersion of the catalytically active metal through the refractory support may be even or the catalytically active metal may be dispersed with a hammock profile. By the term “hammock profile” we mean that the concentration of the catalytically active metal reduces from the surface of the support towards the interior of the support but that the lowest concentration is above zero. Such profiles may be observed, for example with rhodium catalysts. The refractory oxide catalyst support for such catalysts preferably comprises zirconia, alumina or a metal aluminate, such as calcium aluminate or magnesium aluminate.

Alternatively, the first particulate steam reforming catalyst may comprise a catalytically active metal consisting of one or more of platinum, palladium, iridium, ruthenium or rhodium in an eggshell coating on a refractory support. In some arrangements, the particulate catalyst in the first layer may comprise 0.01-1.00% by weight rhodium in an eggshell coating on a refractory oxide catalyst support. The refractory oxide catalyst support for such catalysts preferably comprises alumina and/or zirconia.

The thickness of the eggshell layer of platinum, palladium, iridium, ruthenium or rhodium in the first particulate steam reforming catalyst is preferably ≤1000 μm, more preferably ≤800 μm, most preferably ≤600 μm. The minimum thickness of the eggshell layer may be 20 μm. The thickness of the layer may readily be established using electron probe microanalysis (EPMA) or optical microscopy on cross-sectioned catalysts.

The particulate steam reforming catalyst in the first layer may be prepared by conventional impregnation methods whereby a suitable catalyst support is immersed in or sprayed with a solution of the catalytically active metal such that the solution enters the pores of the support transporting the metals within the particles. The treated supports may then be dried and calcined using conventional methods and equipment.

Suitable first layer catalysts may consist of nickel or rhodium on a refractory oxide comprising alumina, zirconia, magnesium aluminate or calcium aluminate. Such catalysts are commercially available, for example as KATALCO® 28-4, KATALCO® 54-8, or KATALCO® 89-6, available from Johnson Matthey PLC.

The first particulate steam reforming catalysts and the second particulate steam reforming catalyst do not have the same composition. Furthermore, the first particulate steam reforming catalyst does not include a nickel eggshell catalyst, i.e. does not comprise nickel in an eggshell coating on a refractory support.

The second particulate steam reforming catalyst comprises an eggshell catalyst containing nickel coated on a refractory support. The refractory support for the first particulate steam reforming catalyst may comprise alumina, calcium aluminate, ceria, titania, zirconia or magnesia or mixtures thereof. Alumina, magnesium aluminate or calcium aluminate supports are preferred. Alternatively, zirconia supports, which have a lower volatility than alumina or the metal aluminate supports may be used. Preferred zirconia supports are stabilised zirconias, such as magnesia-, calcia-, lanthana-, yttria- or ceria-stabilised zirconias, which are most preferably in the cubic form. Such zirconias are known and are commercially available. Yttria-stabilised cubic zirconia is most preferred.

The thickness of the eggshell layer containing nickel in the second particulate steam reforming catalyst is preferably ≤1000 μm, more preferably ≤800 μm, most preferably ≤600 μm. The minimum thickness of the eggshell layer may be 100 μm. The thickness of the layer may readily be established using electron probe microanalysis (EPMA) or optical microscopy on cross-sectioned catalysts.

Such eggshell catalysts and methods for their preparation are described, for example, in WO2010125369 A2, WO2012056211 A1, WO2015155175 A1 and WO2020234561 A1.

The second particulate steam reforming catalyst may, in particular, be prepared by a method comprising the steps of: (i) preparing a calcined shaped alkaline earth metal aluminate catalyst support, (ii) treating the calcined shaped alkaline earth metal aluminate support with water or a gas containing water vapour to form a hydrated support, (iii) with or without an intervening drying step, impregnating the hydrated support with an acidic solution containing nickel and drying the impregnated support, (iv) calcining the dried impregnated support, to form a calcined catalyst having a nickel oxide concentrated at the surface of the support and (v) optionally repeating steps (ii), (iii) and (iv). The calcined alkaline earth metal aluminate may be prepared by shaping an alkaline earth metal aluminate powder by pelleting, curing the shape with water, which may contain dissolved alkali metal or alkaline earth metal salts, and drying, typically below 200° C. Curing of the composition increases its strength, which is especially desirable when the catalyst is to be used for steam reforming. The shaped support is desirably calcined, i.e. the shaped alkaline earth metal aluminate support has been subjected to a heating step, preferably in the range 400-1400° C. in air or an inert gas, to alter its physiochemical properties before the hydration treatment with water or humid gas. Calcination is preferably carried out by heating the shaped units to between 500 and 1200° C. in air for between 1 and 16 hours. The calcined shaped alkaline earth metal aluminate support preferably has a total surface area, as measured by nitrogen absorption, of 0.5 to 40 m²g⁻¹ , particularly 1 to 15 m²g⁻¹ , and a pore volume of 0.1 to 0.3 cm³g⁻¹ , as determined by mercury porosimetry. Prior to the final calcination, the shaped alkaline earth metal aluminate support may be “alkalised” by impregnation with a solution of an alkali metal compound, such as potassium hydroxide. This serves to minimise lay down of carbon on the catalyst during steam reforming. Alkali oxide, e.g. potash, levels of up to about 5% wt on the calcined support may be used. Similarly, prior to the final calcination, the shaped support may be “activated” by impregnation with a solution of an alkaline earth metal compound, such as calcium nitrate or calcium hydroxide, which is converted into the alkaline earth metal oxide by the calcination. Including an alkaline earth metal compound in this way may be preferable to including lime directly, for example when the alkaline earth metal aluminate is magnesium aluminate.

Prior to impregnation with nickel, the calcined shaped alkaline earth metal aluminate support may be subjected to a treatment with water or a gas containing water vapour to form a hydrated support. The water used may be mains water or process water, but desirably has a low level of dissolved salts, preferably below 150 mg/litre. Demineralised water may also be used. The treatment may be at a temperature in the range of 40 to 99° C. The treatment pressure may be at atmospheric pressure or may be above atmospheric pressure. The treatment may be applied for 1 hour to 10 days, or longer if desired, although shorter periods in the range of 8-24 hours are preferred. If a drying step is performed, it may be achieved in the normal manner, for example by exposing the treated support to a gas, such as dry air or dry nitrogen, to temperature in the range of 50-120° C.

The treated hydrated catalyst support, with or without an intervening drying step, may be impregnated with an acidic solution comprising one or more soluble nickel compounds. Aqueous impregnation solutions are particularly suitable. The acidic impregnation solution comprises one or more acidic compounds, i.e. compounds that dissolve in water to give acidic solutions (i.e. the impregnation solution desirably has a pH <7.0). Suitable acidic metal compounds include nickel nitrate, nickel acetate nickel citrate and nickel oxalate. Where the impregnated metal is nickel, the metal compound used to impregnate the hydrated support is preferably nickel nitrate or nickel acetate.

Following impregnation of the hydrated support with the acidic impregnating solution, the impregnated support may be dried and calcined. Drying conditions are suitably at a temperature in the range 25-250° C., preferably in the range 50-150° C. at atmospheric or reduced pressure. Drying times may be in the range 1-24 hours. The calcination step of the dried impregnated support to convert the impregnated nickel compound to nickel oxide is preferably performed in air at a temperature in the range 250-850° C.

The nickel content of the second particulate steam reforming catalyst is preferably in the range 1-25% wt, preferably 1-15% wt, more preferably 1-10% wt. Thus, one impregnation may be sufficient to generate the desired catalyst. However, if desired, impregnation, drying and calcination steps (ii), (iii) and (iv) may be repeated until the nickel oxide content of the calcined catalyst is at the desired level.

A particularly suitable second particulate steam reforming catalyst consists of nickel in an eggshell layer on a support comprising magnesium aluminate or calcium aluminate. Such catalysts are commercially available, for example as KATALCO® 57-6, available from Johnson Matthey PLC.

The particulate catalysts in the layers are desirably shaped into pellets using known pelleting techniques but may also be prepared as extrudates or spherical granules. The length, width and height of such particulate catalysts may be in the range 3-50 mm. Preferably, the smallest dimension of the particles in the layers, (i.e. the length, width or height), is at least 10 mm and the largest dimension (i.e. length, width or height) is not more than 40 mm. The particulate catalyst may be in any suitable shape but preferably are in the form of cylinders, which may have one or more through holes. More preferably, the catalysts are in the form of a cylindrical pellet having between 1 and 12 holes extending there-through, especially 3-10 holes of circular cross section. The catalysts may have between 2 and 20 flutes or lobes running along the length of the pellet. Suitable diameters for such cylindrical pellets are in the range 4-40 mm and the aspect ratio (length/diameter) is preferably ≤2. The cylinders may be domed or flat-ended. Preferred shapes include a 4-hole quadralobe, a 5-hole pentalobe, a 7-hole cylinder and a 10-hole cylinder.

The shape and size of the catalyst particles in the layers may be optimised to maximise the available surface area and minimise the pressure drop through the bed. As the size of the particles is decreased, the surface area increases, the voidage decreases and in consequence the pressure-drop increases. The voidage of the bed may be maximised by using shapes with internal through-holes and external features such as lobes and grooves.

The catalyst bed comprises the layers of the first and second particulate steam reforming catalysts. The first and second layers are in contact with each other and arranged such that the partially combusted gas passes though the layer of the first catalyst and then immediately through the layer of the second catalyst. Accordingly, the first particulate catalyst makes up a first layer of the catalyst bed and the second particulate catalyst makes up a second layer within the catalyst bed. One or more layers of particulate inert material may be provided above and/or below the layers of the first and second particulate catalysts.

The catalyst bed may be cylindrical in shape with a diameter in the range 1-5 metres. The length or thickness of the catalyst bed comprising the first and second layers will depend upon the activity of the catalytically active metals, the conditions under which it is operated and whether the feed gas is a hydrocarbon/steam mixture or a pre-or primary-reformed gas. The combined thickness of the first and second layers in the bed of steam reforming catalyst in the secondary or autothermal reformer may be in the range 1-10 metres, preferably 2-5 metres.

In the present invention, the first layer of particulate steam reforming catalyst comprises between 20 and 60% of the combined thickness of the first and second layers. Accordingly, the second layer of the particulate steam reforming catalyst, i.e. the eggshell catalyst comprising nickel coated on a refractory support, has a thickness that is between 40 and 80% of the total thickness of the first and second layers. Preferably the first layer thickness is between 40 and 60% of the combined thickness of the first and second layers.

It will be understood by those skilled in the art that it may be useful to graduate the activity of the steam reforming catalyst through the bed. Therefore, the first layer may comprise two or more successive layers of a steam reforming catalyst, the two or more successive layers having a lower catalytic activity than that preceding it.

If desired a layer of zirconia balls, pellets or tiles may be placed on the first layer of catalyst to protect the surface of the catalyst from irregularities in the combusting gas flow from the upstream combustion zone. Zirconia is inert and not catalytically active for the steam reforming reactions. However, a benefit of providing this layer is to prevent disturbance of the surface of the catalyst bed by the flame generated by the burner.

The invention is further illustrated by reference to the following calculated examples.

In all of the examples, the performance of the eggshell nickel catalysts is similar to that of the non-eggshell nickel catalyst, provided that no vaporisation of the catalyst takes place. However, vaporisation of the first catalyst's refractory support may occur in the first layer at the top of the bed. This is explored in Examples 1 and 2 below. Example 3 demonstrates the economic benefit of replacing a significant portion of the catalyst bed with eggshell catalyst.

### Example 1

Drawing on Example 1 from WO2006/126018, a 4 m diameter autothermal reformer containing a particulate alumina-supported nickel steam reforming catalyst processing 8000 mtpd of reformed gas at above 900° C. would vaporise 4.4 kg/day of alumina support from the top of the bed. Volatilisation of the catalyst occurs in the top 0.3 m of the bed, before the gas cools and deposition occurs. If the bed is comprised entirely of 4-hole cylindrical pellets of eggshell nickel catalyst, it would take only 79 days to render it inert if the nickel-containing layer is 100 μm thick, or 256 days if it is 300 μm thick. This is an undesirably short lifespan for a catalyst in this application.

### Example 2

For the autothermal reformer as described in Example 1, the top 50% of the thickness of the bed was replaced with fully impregnated non-eggshell nickel catalyst of the same shape as the first layer. Because the nickel is distributed throughout the support activity will be completely lost only when all of the catalyst is vaporised. The vaporisation rate will be similar to Example 1, as will the affected bed depth, because the catalyst support is the same material. In this case, it will take more than 2 years to completely inert the catalyst. This is a more reasonable lifespan for the catalyst at the very top of a secondary reformer. In addition, the lifespan can be further extended through the use of zirconia hold down material at the top of the bed.

### Example 3

For the autothermal reformer described in Example 1, for a bed length of 4 metres, then the total mass of nickel required if the entire bed is fully-impregnated non-eggshell catalyst is approximately 3540 kg for a typical 8% wt nickel catalyst. If the lower 50% of the bed is replaced with a 1% wt nickel eggshell catalyst as the second layer, the total mass of nickel required in the bed is reduced by about 43.8% to 1990 kg, leading to significantly lower cost.

1. A process for steam reforming in an autothermal or secondary reformer comprising: (i) non-catalytically partially combusting a feed gas comprising a hydrocarbon with an oxygen-containing gas to form a partially combusted gas mixture and (ii) passing the partially combusted gas mixture through a catalyst bed comprising a first layer of a first particulate steam reforming catalyst and a second layer of a second particulate steam reforming catalyst, wherein the partially combusted gas mixture passes through the first layer and then the second layer, the second particulate steam reforming catalyst is an eggshell catalyst comprising nickel coated on a refractory support, and the first layer has a thickness in the range of 20 to 60% of the combined thickness of the first and second layers.

2. The process according to claim 1, wherein the feed gas comprises a desulphurized hydrocarbon feedstock or is a pre-reformed or primary-reformed gas stream comprising unreacted hydrocarbon, steam, hydrogen, carbon dioxide and carbon monoxide.

3. The process according to claim 1, wherein the oxygen-containing gas is air or oxygen-enriched air.

4. The process according to claim 1, wherein the first particulate steam reforming catalyst comprises nickel dispersed throughout a refractory support.

5. The process according to claim 1, wherein the first particulate steam reforming catalyst consists of one or more of platinum, palladium, iridium, ruthenium or rhodium dispersed throughout a refractory support or as an eggshell coating on a refractory support.

6. The process according to claim 4, wherein the refractory support for the first particulate steam reforming catalyst comprises alumina, calcium aluminate, ceria, titania, zirconia or magnesia or mixtures thereof.

7. The process according to claim 1, wherein the refractory support for the second particulate steam reforming catalyst comprises alumina, calcium aluminate or magnesium aluminate.

8. The process according to claim 1, wherein the first layer is between 40 and 60% of the combined thickness of the first and second layers.

9. The process according to claim 1, wherein a layer of zirconia balls, pellets or tiles is placed on the first layer.

10. A bed of steam reforming catalyst suitable for use on a secondary or autothermal reformer, wherein the bed comprises a first layer of a first particulate steam reforming catalyst and a second layer of a second particulate steam reforming catalyst in contact with the layer of first particulate steam reforming catalyst, wherein the second particulate steam reforming catalyst is an eggshell catalyst comprising nickel coated on a refractory support, and the first layer has a thickness in the range of 20 to 60% of the combined thickness of the first and second layers.

11. The bed of steam reforming catalyst according to claim 10, wherein the first layer of the first particulate steam reforming catalyst comprises nickel dispersed throughout a refractory support.

12. The bed of steam reforming catalyst according to claim 10, wherein the first layer of first particulate steam reforming catalyst consists of one or more of platinum, palladium, iridium, ruthenium or rhodium dispersed throughout the refractory support or as an eggshell coating on the refractory support.

13. The bed of steam reforming catalyst according to claim 11, wherein the refractory oxide catalyst support for the first particulate steam reforming catalyst comprises alumina, calcium aluminate, ceria, titania, zirconia or magnesia or mixtures thereof.

14. The bed of steam reforming catalyst according to claim 10, wherein the refractory oxide catalyst support for the second particulate steam reforming catalyst comprises alumina, calcium aluminate or magnesium aluminate.

15. The bed of steam reforming catalyst according to claim 10, wherein the first layer has a thickness between 40 and 60% of the combined thickness of the first and second layers.

16. The bed of steam reforming catalyst according to claim 10, wherein an inert layer of zirconia balls, pellets or tiles is placed on the first layer.
